(19) United States
(12) Patent Application Publication
(10) Pub. No.: US 2008/0250093 A1
(43) Pub. Date: Oct. 9, 2008

(54) Method and Apparatus for Filtering Multiple Channels of Signals

(75) Inventors: Xia Zhu, Shanghai (CN); Yan Li, Shanghai (CN); Liangliang Hu, Shanghai (CN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/090,035

(22) PCT Filed: Oct. 9, 2006
(86) PCT No.: PCT/IB06/53695

§ 371 Date: Apr. 11, 2008

(30) Foreign Application Priority Data
Oct. 13, 2005 (CN) 00510113463.X

(51) Int. Cl. G06F 17/10

(52) U.S. Cl. 708/316

(57) ABSTRACT

To reduce chip size and lower cost by using a method of multiplexing a device to filter a plurality of signals, the present invention provides an apparatus for filtering the plurality of signals, comprising: a group of storage units, for storing the plurality of signals, wherein the group of storage units comprises a plurality of storage units, each of which is used to store corresponding signal segments in each signal and output the stored signal segments in a predefined order; and a processing module, for weighting and combining the output signals from the group of storage units, to obtain a plurality of filtered signals corresponding to the multiple channels of signals. The group of storage units may further comprise a group of combining units, for combining output signal segments from the storage units to be processed with a same weight value. The present invention further provides the corresponding method for filtering a plurality of signals. With the method and apparatus of the present invention, the filter size may be reduced significantly and the cost may be lowered.

### FIELD OF THE INVENTION

The present invention relates generally to a wireless communication system and device, and more particularly, to a method and apparatus for filtering multiple channels of signals in a multi-antenna wireless communication system and device.

### BACKGROUND OF THE INVENTION

With the rapid development of wireless communication technology, it becomes more and more necessary to provide a high-speed, broadband, good anti-interference air interface to the system. In recent years, the diversity technique is widely used due to its good characteristics in resisting channel distortions, and improving transmission quality and capacity. With communication system requirements going higher, however, the diversity information obtained from a conventional single antenna cannot fully meet the requirements and thus multi-antenna techniques gradually become a hot spot in research and development. Multi-antenna techniques, such as Smart Antenna, MIMO (Multiple Input Multiple Output) or the like, have become the research trends for future communication systems and have been formally adopted by some standards, such as 3GPP.

In a multi-antenna wireless communication system, multiple antennas are used to transmit and receive signals simultaneously and independently. Each antenna has its corresponding independent RF channel. Signals received from different antennas are forwarded to a baseband processing unit in parallel via their respective RF channels, and multiple channels of signals from the baseband processing unit are transmitted to each antenna in parallel via their respective RF channels.

To suppress OOB (out-of-band) distortion and cancel ISI (Inter-Symbol Interference) in wireless communication systems, PSFs (pulse shaping filters) are typically employed in transmitters to limit the spectral energy of baseband signals to a limited bandwidth, and MFs (match filters) are adopted in receivers to suppress OOB noises and improve SNR (Signal to Noise Ratio). For example, 3GPP has adopted RRC(Root Raised Cosine) filters and SRRC(Square Root Raised Cosine) filters as the PSFs and MFs. Alternatively, other filters, such as conjugate root pulse filter, may be used in transmitters and receivers.

Accordingly, there will be a plurality of parallel PSFs in a multi-antenna transmitter and a plurality of parallel MFs in a multi-antenna receiver. This structure brings some redundancy, for example, in a receiver having m antennas, m channels of signals are received from or sent to the m antennas, and thus requiring at least m MFs. When one channel of signal is splitted into two components, such as I (In-phase) and Q (Quadrature) components, two MFs will be needed for processing one channel of signal and thus the receiver will need 2 m MFs in total. The bigger the number of antennas is, the more the redundancy will be.

FIG. 1A shows a conventional transmitter having four antennas, in which square root raised cosine filters (SRRCs) are adopted as PSFs. As shown in the figure, a data processing unit, such as a baseband processor or an interleaver or the like, generates four channels of signals to be respectively fed into four parallel SRRCs for pulse shaping filtering, and the four channels of filtered signals are then fed into four modulation units respectively and transmitted via four antennas respectively.

FIG. 1B shows a conventional receiver having four antennas, in which square root raised cosine filters (SRRCs) are adopted as MFs. Four channels of signals reach four SRRCs respectively through four parallel antennas, four parallel RF front ends and four parallel ADCs, and four channels of match-filtered signals are fed respectively into a subsequent unit, such as a baseband data processing unit.

In current systems, since the process performed by the PSFs and MFs are independent of the physical channels for transmitting radio signals, the structures of the PSFs/MFs corresponding to various antennas are identical, which thus brings some redundancy in the structure. It may be seen from FIGS. 1A and 1B that the four SRRCs in the transmitter have an identical structure and the four SRRCs in the receiver also have an identical structure. It will be noted that FIGS. 1A and 1B exemplifies a single channel of signal, each single channel of signal not being splitted into I and Q components.

This redundancy in the structure increases the chip size and cost significantly. Therefore, there is a need for a novel method and apparatus to mitigate such redundancy to reduce the chip size and lower the cost.

### SUMMARY OF THE INVENTION

An object of the present invention is to provide a method and apparatus for use in a multi-antenna wireless communication system and device, which reduces the number of filters and decreases the chip size and the cost significantly by multiplexing a filter to filter a plurality of signals. The plurality of signals corresponds to a plurality of channels. In this application, a signal refers to a signal stream inputted into the system and apparatus employing the method of the present invention, such as a filter, and each signal comprises a plurality of signal segments. The plurality of signals refer to a plurality of signal streams inputted in parallel, serially or in some other orders, into the system and apparatus employing the method of the present invention.

An apparatus for filtering a plurality of signals according to the present invention, comprises: a group of storage units, for storing the plurality of signals, wherein the group of storage units comprises a plurality of storage units, each of which is used to store corresponding signal segments of each signal and output the stored signal segments in a predefined order; and a processing unit, for weighting and combining the output signals from the group of storage units, so as to obtain a plurality of filtered signals corresponding to the plurality of signals. The group of storage units may further comprise a group of combining units, for combining the output signal segments from the storage units to be processed with a same weight value.

A method for filtering a plurality of signals according to the present invention, comprises the steps of: storing the plurality of signals in a group of storage units having a plurality of storage units, each of which stores corresponding signal segments of each signal; outputting the signal segments stored in the group of storage units in a predefined order; and weighting and combining the output signals from the group of storage units, to obtain a plurality of filtered signals corresponding to the plurality of signals.

By multiplexing filters, this method reduces the number of filters required in a wireless communication device to 1. Furthermore, filtering of a plurality of signals is implemented by multiplexing the group of weighting units in the filter, which reduces the number of required weighting units and thus realizes the purpose of reducing the chip size. Generally, the weighting unit is implemented with a multiplier unit. For example, for a transmitter/receiver having m antennas, when a signal comprises I component and Q component, the number of the required filters reduces to 1 from 2 m of the conventional method, and the number of groups of weighting units reduces to 1 group from 2 m groups of the conventional method.

The method may further comprise the step of combining the output signal segments from each of the storage units to be processed with a same weight value.

This optimal method further reduces the number of weighting units in the group of weighting units and thus further reduces the chip set by combining signals to be processed with a same weight value and then weighting the combined signals, using the even function or odd function property of the mathematical expression of the filter or symmetric property of some coefficients of the mathematical expression of the filter. For example, for a filter whose mathematical expression is even function, the number of its weighting units reduces half approximately.

Other objects and attainments together with a fuller understanding of the invention will become apparent and appreciated by referring to the following descriptions and claims taken in conjunction with the accompanying drawings.

### BRIEF DESCRIPTION OF THE DRAWINGS

FIG. 1A shows a prior-art transmitter, in which square root raised cosine filters (SRRCs) are adopted as PSFs;

FIG. 1B shows a prior-art receiver, in which square root raised cosine filters (SRRCs) are adopted as MFs;

FIG. 2A shows a transmitter according to an embodiment of the present invention;

FIG. 2B shows a receiver according to an embodiment of the present invention;

FIG. 3 is a block diagram according to an embodiment of the present invention;

FIG. 4 is a block diagram showing details of a storage unit;

FIG. 5A is a schematic diagram showing the signal structure;

FIG. 5B is a schematic diagram showing the case in which signal segments are stored in a group of storage units at an instant t;

FIG. 5C is a schematic diagram showing the circular output according to an embodiment of the present invention;

FIG. 6 is a block diagram according to an embodiment of the present invention, in which the mathematical expression of the filter is an even function and the number of storage units in the present embodiment is even;

FIG. 7 is a block diagram according to an embodiment of the present invention, in which the mathematical expression of the filter is an even function and the number of storage units in the present embodiment is odd;

FIG. 8 shows a block diagram in which a stabilizer precedes a group of storage units according to an embodiment of the present invention; and

FIG. 9 shows a block diagram in which a selector selects different weight coefficients for different signals according to an embodiment of the present invention.

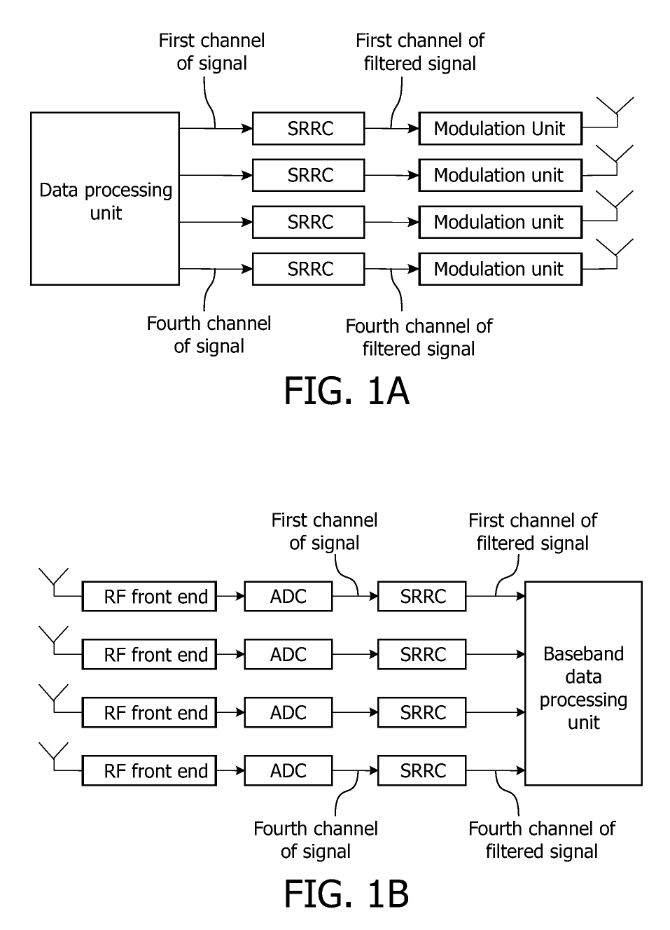

Throughout all the above drawings, like reference numerals will be understood to refer to like, similar or corresponding features or functions.

### DETAILED DESCRIPTION OF THE INVENTION

Detailed description will be made in conjunction with the accompanying drawings below to the method and apparatus of the present invention for filtering a plurality of signals by multiplexing a filter.

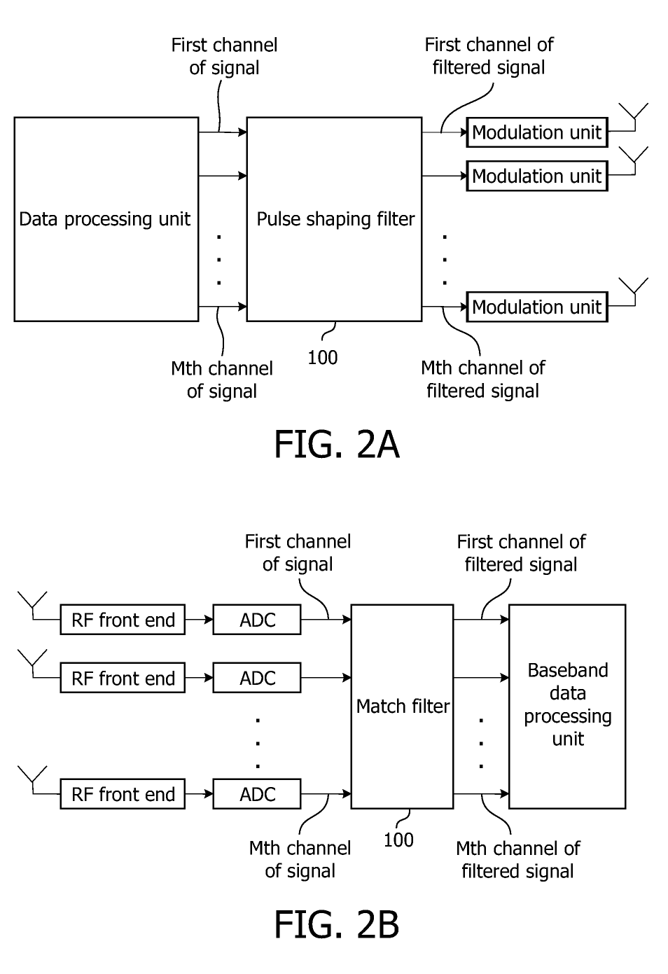

FIG. 2A is a block diagram showing a transmitter according to an embodiment of the present invention. In FIG. 2A, a PSF 100 is used to perform pulse shaping on a plurality of signals in the transmitter. The filter 100 concurrently receives the plurality of signals sent from a data processing unit and performs pulse shaping on them, and then outputs the plurality of filtered signals in parallel to a subsequent unit, such as modulation units.

FIG. 2B is a block diagram showing a receiver according to an embodiment of the present invention. In FIG. 2B, a MF 100 is used to perform match filtering on a plurality of signals sent from a plurality of RF devices and transmits the filtered signals to the subsequent unit, such as a baseband data processing unit.

It may be seen from FIG. 2A and FIG. 2B that the plurality of signals may be filtered with a method of multiplexing a filter, which reduces the number of filters in a wireless communication system and device. RRC and SRRC may be used to implement the filter 100 in FIG. 2A and FIG. 2B. Alternatively, other filters, such as conjugate root pulse filter, may be used to implement the filter 100. Typically, when the transmitter adopts a SRRC filter, the receiver will use a corresponding SRRC filter. When the transmitter/receiver adopts a RRC filter, the corresponding receiver/transmitter may not use the corresponding RRC filter or other filters.

In the present application, descriptions are made to the method of the invention by exemplifying RRC filters. It will be understood by those skilled in the art that the present invention is not limited to RRC filters, other filters using different algorithms are equally applied to the present invention.

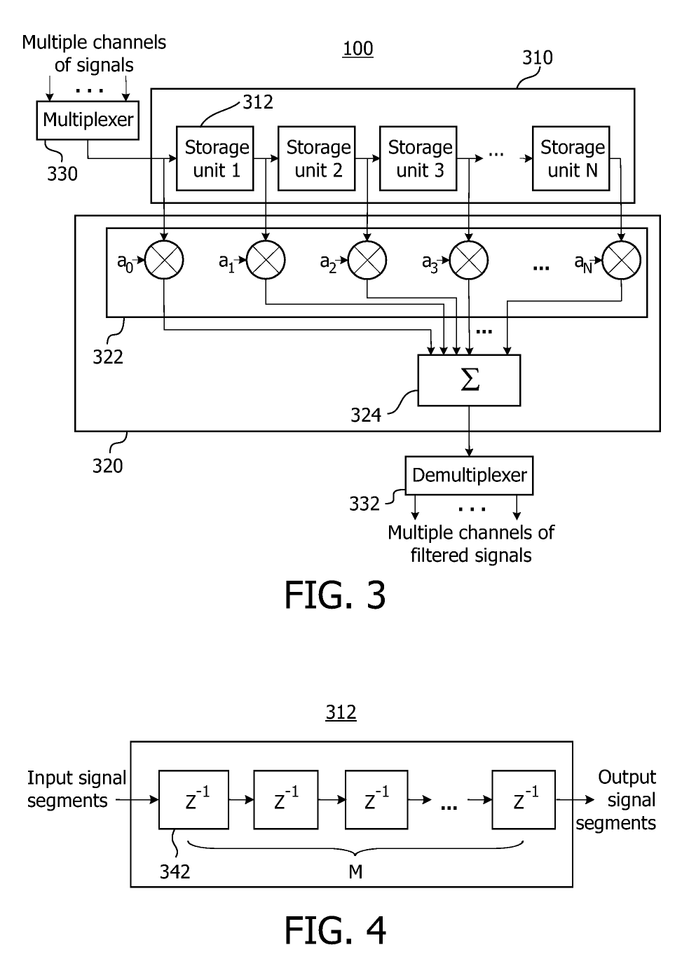

FIG. 3 is a block diagram showing a filter according to an embodiment of the present invention. Filter 100 comprises a group of storage units 310 and a processing module 320. The group of storage units 310 comprises a plurality of storage units 312, for storing the first signal to the M^{th} signal. The processing module 320 comprises a group of weighting units 322 and a group of combining units 324, for weighting and combining the signal segments outputted from the group of storage units 310, to obtain the plurality of filtered signals corresponding to the plurality of signals. In FIG. 3, N storage units 312 are connected serially, and they may also be connected in parallel or in other ways.

Optionally, the filter 100 of FIG. 3 may further comprise a multiplexer 330, for multiplexing the M signals and inputting the multiplexed signals into the group of storage units 310. The sample rate for the multiplexer 330 may be M times the rate for a single signal, to guarantee a proper multiplexing. The principle and design of a multiplexer are known to those skilled in the art. Optionally, the filter 100 may further comprise a demultiplexer 332, for demultiplexing the signal segments outputted from the group of combining units 324, that is, the multiplexed filtered signals corresponding to the M signals, as the filtered signals corresponding to the first signal to the M^{th} signal, and outputting them to a subsequent unit in parallel, such as a modulation unit or a baseband processing unit.

The group of storage units 310 comprises a plurality of storage units 312, the number N of which depends on the filtering algorithm adopted by the filter. Each storage unit 312 stores a corresponding part of each signal, that is, each storage unit 312 stores the corresponding signal segments in the M signals, which are from the first signal to the M^{th} signal, and each signal has a signal segment stored in each storage unit, that is, each signal has its signal segment stored in the N storage units. A part of a signal, that is, one or a plurality of signal segments, may be represented as the samples of this signal at one or multiple instants. During a same clock cycle, the output signal segments of each storage units correspond to the same signal, while during different clock cycles, signal segments corresponding to different signals are outputted circularly in a certain order. Here, the current input signal segment for the group of storage units may be regarded as the output signal segment from the 0^{th} storage unit and is involved in this corresponding process. The order described herein guarantees that the synchronous outputs from all the storage units 312 may ergodic spread over each signal in a relatively long time period, so as to realize the circular output. Therefore, the circular output has the characteristic of ergodicity in mathematics aspect. Descriptions will be made below to the process of circular output.

The group of weighting units 322 is used to weight the signal segments outputted from the group of storage units 310 with a group of weight coefficients. Here, the group of weighting units 322 comprises a plurality of weighting units, each of which weights a signal segment with a weight coefficient. The input signal segment for a weighting unit may be the output signal segment from a storage unit 312, or the current input signal segment from the group of storage units 310. Therefore, the current input signal segment for the group of storage units 310 may be regarded as the output signal segment for the 0^{th} storage unit 312. According to the algorithm adopted by the filter 100, the weighting unit may weight a real number or a complex number.

In FIG. 3, the group of adding units 324 adds the output signal segments from the group of weighting units 322, as the multiplexed plurality of filtered signals corresponding to the 1^{st} to M^{th} signal, and outputs them to the subsequent unit.

FIG. 4 shows details of a storage unit of the present invention. Each storage unit 312 comprises a group of memory elements 342, each of which stores a signal segment, and each signal has a signal segment stored in the group of memory elements 342. The number of storage units 342 is not less than the number of the signals, for the purpose of guaranteeing that each signal has at least one signal segment stored in the group of memory elements 342. Typically, the memory element 342 may be implemented with a Z⁻¹ delayer, or other form of circuits or devices, such as D trigger, delay register and the like. In FIG. 4, the M memory elements 342 are connected serially, and they may also be connected in parallel or in other ways.

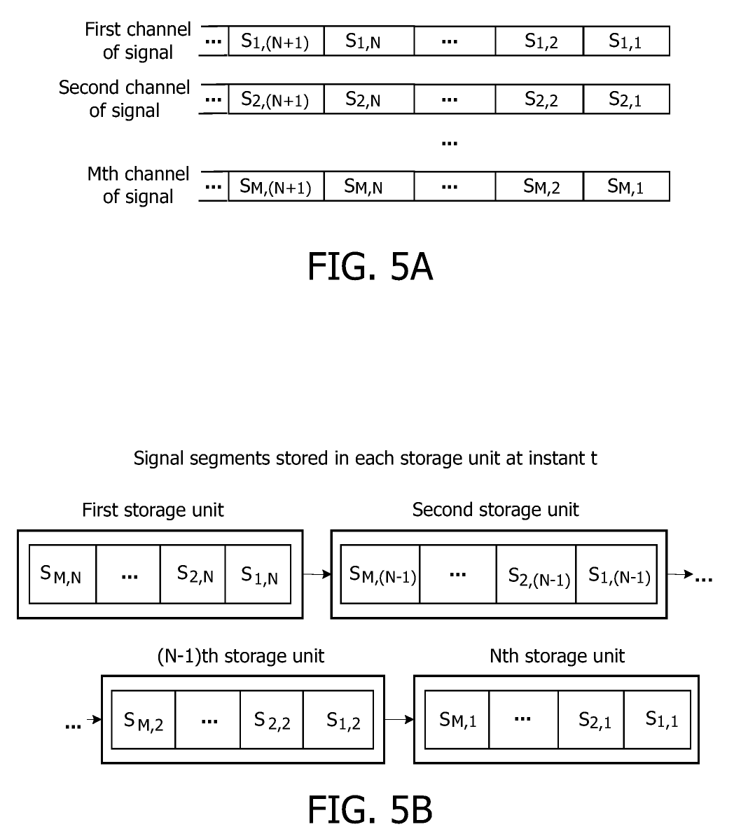

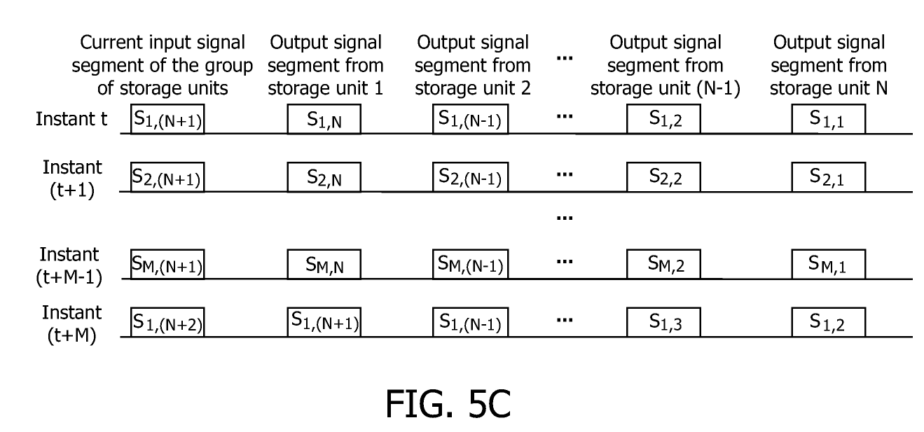

FIG. 5A is a schematic diagram showing the structure for each signal. In the figure, each signal includes a plurality of signal segments, for example, the 1^{st} signal comprises signal segments {S_{1,1},S_{1,2}. . . ,S_{1,N}S_{1,(N+1)}, . . . }.

FIG. 5B shows the case in which signal segments are stored in a group of storage units 310 at instant t. It may be seen that the earlier a signal segment is inputted, the latter storage unit it will be stored in. For example, S_{1,1} is stored in the N^{th} storage unit, and S_{1,N} is stored in the 1^{st} storage unit. It's to be noted that the signal segments are stored in each storage unit in a serial manner in FIG. 5B, but it's also possible to be stored in a parallel manner or other manners. At instant t, the current input signal segment for the group of storage units 310 is S_{1,(N+1)}.

FIG. 5C is a schematic diagram showing the circular output of the filter 100. Also, this figure may be used to depict the process of multiplexing the filter. Here, S_{i,j} represents the j^{th} signal segment of the i^{th} signal outputted from one of the storage units 312 at the current instant, i∈{1,M}, j∈{1,N}. An assumption is made that the output signal segments from all storage units 312 and the current input signal segments for the group of storage units 310 are synchronized to correspond to the 1^{st} signal at instant t. Here, the group of weighting units 322 and the group of combining units 324 perform filtering on the current signal segments of the 1^{st} signal, i.e. (S_{1,1},S_{1,2}, . . . , S_{1(N-1)}, S_{1,(N-1)},S_{1(N+1)}), where S_{1,(N+1)} is the current input signal segment for the group of storage units and happens to be the (N+1)^{th} signal segment of the 1^{st} signal. At instant (t+1), by the delaying operation of the Z⁻¹ delayer, the output signal segments from all storage units 312 and the current input signal segments for the group of storage units 310 are synchronized to correspond to the 2^{nd} signal. Thus, the group of weighting units 322 and the group of combining units 324 perform filtering on the current signal segments of the 2^{nd} signal, i.e. (S_{2,1},S_{2,2}, . . . ,S_{2,(N-1)},S_{2,N},S_{2,(N+1)}, where S_{2(N+1)} is the current input signal segment for the group of storage units and happens to be the (N+1)^{th} signal segment of the 2^{nd} signal. Similarly, at instant (t+M−1), by the delaying operation of the Z⁻¹ delayer, the output signal segments from all storage units 312 and the current input signal segments for the group of storage units 310 are synchronized to correspond to the M^{th} signal. Thus, the group of weighting units 322 and the group of combining units 324 perform filtering on the current signal segments of the M^{th} path of signal, i.e. (S_{M,1},S_{M,2}, . . . ,S_{M,(N-1)},S_{M,N},S_{M,(N+1)}). At instant (t+M), the output signal segments from all storage units 312 and the current input signal segments for the group of storage units 310 are synchronized to correspond to the 1^{st} signal, and the filter 100 filters the current signal segments (S_{1,2},S_{1,3}, . . . ,S_{1,N},S_{1,(N+1)},S_{1,(N+2)}) of the 1^{st} signal again, and this is the circular output. From mathematics aspect, the operation has the characteristics of ergodicity.

It may be understood by those skilled in the art that the current input signal segments for the group of storage units 310 are equivalent to the output signal segments for the 0^{th} storage unit during circular output and multiplex process by adding a 0^{th} storage unit before the 1^{st} storage unit. This variation is made without departing from the scope of the present invention.

It may be seen from FIG. 5C that circular output of a plurality of storage units may be implemented with the present invention, that is, at the same instant, the output signal segments from each storage unit 312 correspond to the same signal, and at different instants, the output signal segments from each storage unit 312 circularly correspond to different signals in a predefined order. It's to be noted that the sequential circulation is merely an example. Also, the circular correspondence of the present invention may be realized with other circulation method such as reverse order circulation or a particular circulation order.

The present invention may filter a plurality of signals through a filter 100 comprising a group of storage units 310, a group of weighting units 322, a group of combining units 324, and optionally a multiplexer 330 and a demultiplexer 332. Compared with the conventional techniques, it is advantageous in that only one filter is required, in particular, the number of weighting units required is same as that of the weighting units included in a prior-art filter. The plurality of signals may be filtered by multiplexing the filter, thus to reduce the chip size greatly.

To further reduce the filter size, the present invention proposes an optimized method, which further reduces the number of weighting units required in the group of weighting units 322, by using the even-function property of part or all of the coefficients in the mathematical expression of the filter 100. The coefficients in the mathematical expression of the filter 100 are represented by the weight coefficients for the weighting units. Generally, the number of coefficients in the mathematical expression determines the number of weighting units in the circuit design, that is, n coefficients will need n weighting units. The present invention takes advantage of the even-function/partial even-function property of the mathematical expression of the filter, that is, some signal segments will be weighted with weight values having the same value. In this application, these signal segments to be weighted with weight values having the same value in weighting operation are referred to as similar terms each other. Similar terms are combined before performing weight operation, that is, signals having similar weight coefficients are combined first and then the combined signals are weighted, to further reduce the number of weighting units required. For example, the mathematical expression of RRC filter is an even function, that is, it has a property aᵢ=a_{N-i-1} for coefficients {aᵢ, i=0,1,2, . . . ,N−1}. With the optimized method, the number of weighting units required may decrease to about half compared to the conventional method. When the mathematical expression of RRC filter is an odd function, that is, it has a property aᵢ=(−a_{N-i-1)}, subtraction may be performed on the signals having opposite coefficients and then weight operation may be performed on the subtracted signals, which also reduces the number of weighting units required. It's to be understood by those skilled in the art that the optimized method of the present invention is not limited to RRC filters, and is equally applicable to other filters whose mathematical expression has odd-function/even-function property or partial symmetric property.

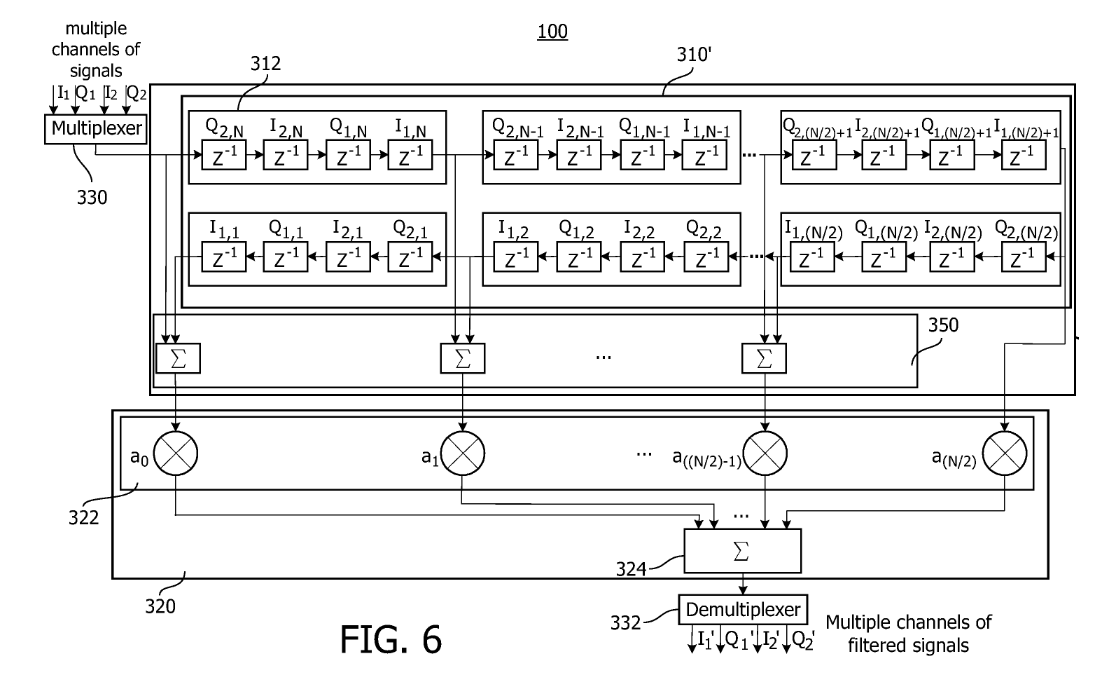

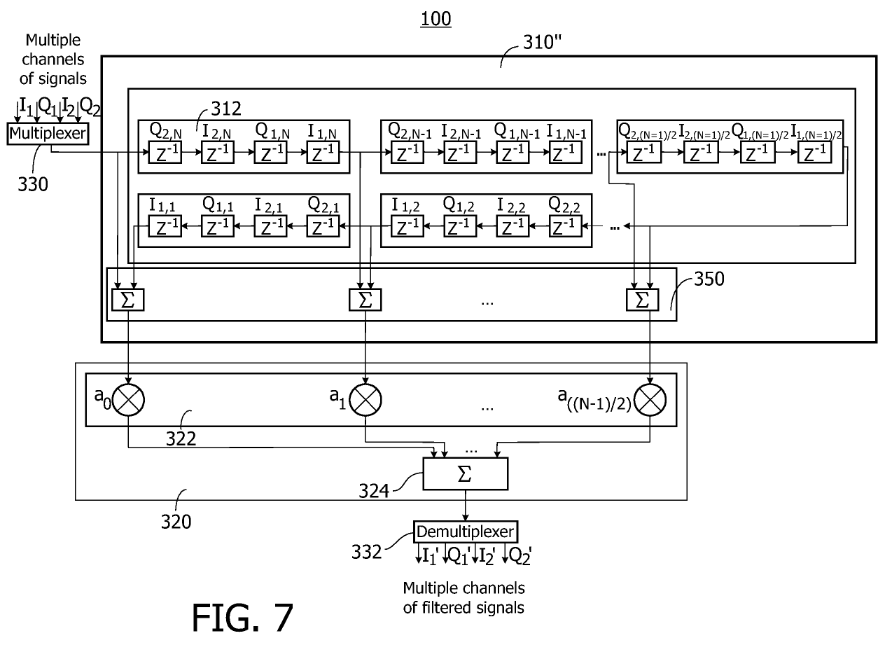

FIG. 6 is a block diagram according to an embodiment of the present invention, in which the mathematical expression of the filter is an even function and the number of storage units in the present embodiment is even. FIG. 7 is a block diagram according to an embodiment of the present invention, in which the mathematical expression of the filter is an even function and the number of storage units in the present embodiment is odd.

In FIG. 6, there are input signals from totally four signals {I₁,Q₁,I₂,Q₂}. Through shift operation, each storage unit 312 stores an input signal segment respectively from {I₁,Q₁,I₂,Q₂}, for example, the N^{th} storage unit 312 stores input signal segments {I_{1,1},Q_{1,1},I_{2,1},Q_{2,1}}, and all storage units implement synchronous output, that is, in an arbitrary clock cycle, the output signal segments from all storage units 312 and the current input signal segments for the group of storage units 310′ are synchronized to correspond to the same signal. As shown in FIG. 6, at the current instant, the output signal segments from all storage units 312 and the current input signal segments for the group of storage units 310′ correspond to the signal I₁, and in the next clock cycle, after shift operation, the output signal segments from all storage units 312 and the current input signal segments for the group of storage units 310′ correspond to the signal Q₁.

Since the current input signal segments for the group of storage units 310′ and the output signal segments from the N^{th} storage unit 312 have the same weight coefficient a₀ in the group of weighting units 322, so they are first fed into an adding unit in the group of combining units 350 for combination and then the combined signal are fed into the corresponding weighting unit to be multiplied with a₀. Similarly, output signal segments from the first storage unit and the (N−1)^{th} storage unit 312 are first fed into the group of combining units 350 for combination and the combined signal is multiplied with a₁ in the corresponding weighting unit. The number of storage units is even in FIG. 6, so the output signal segment from the (N/2)^{th} storage unit is sent to the corresponding weighting unit directly, to be multiplied with a_{(N/2)}. It may also be considered that the output signal is added with 0 and then multiplied with a_{(N/2)}.

The output signal segments from the group of weighting units 322 are added in the group of combining units 324 and the result is outputted to demultiplexer 322 as the plurality of filtered signals and the demultiplexer 332 demultiplexs the serial plurality of filtered signals into parallel filtered signals {I₁′,Q₁′,I₂′,Q₂′} corresponding to the 1^{st} signal to the M^{th} signal.

Different from FIG. 6, the number of storage units 312 in the group of storage units 310′ is odd in FIG. 7. Accordingly, the output signals from the ((N+1)/2)^{th} storage unit and the ((N−1)/2)^{th} storage unit 312 are first fed into the group of combining units 350 for combination and the combined signal is multiplied with the coefficient a_{(N-1)/2} in the corresponding weighting unit.

This optimized method may further reduce the number of weighting units in the group of weighting units 322, thus to further reduce the chip size. Compared with conventional method, the number of weighting units reduces from

$$2 M * ( N + 1 ) to ( \frac{N}{2} + 1 )$$

in FIG. 6, and reduces from

$$2 M * ( N + 1 ) to ( \frac{N + 1}{2} )$$

### in FIG. 7.

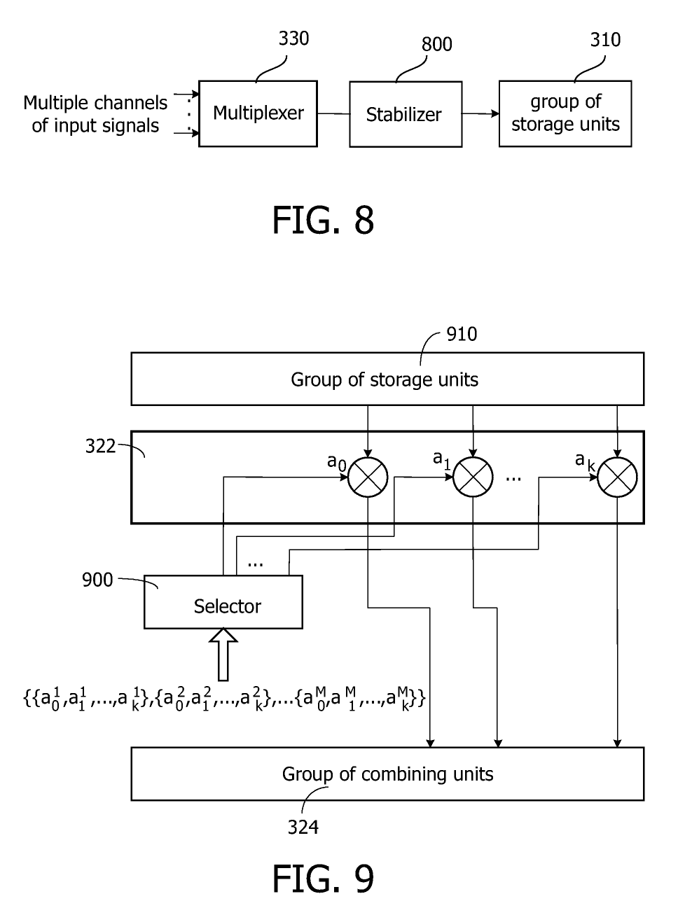

To ensure the input signals for the group of storage units 310 more stable, the present invention proposes a stabilizer 800 added prior to the group of storage units 310, as shown in FIG. 8. The stabilizer 800 may be implemented with a Z⁻¹ delayer, D trigger or other equivalent circuit/device.

In FIGS. 3, 6 and 7, the group of coefficients to be used by the group of weighting units 322 is preset according to the mathematical expression of the filter, and all signals employ the same group of coefficients. To employ different filters for different signals, that is, different weighting coefficients for different signals, the present invention proposes a method of choosing different weighting coefficients for different signals by using a selector. FIG. 9 shows a block diagram in which a selector selects different weight coefficient groups for different signals from a predefined set of weight coefficient groups according to an embodiment of the present invention. In FIG. 9, {a₀¹,a₁¹, . . . aₖ¹},{a₀²,a₁², . . . , aₖ²}, . . . {a₀^{M},a₁^{M}, . . . ,aₖ^{M}}} is a predefined set of coefficient groups, where {a₀ⁱ,a₁ⁱ, . . . ,aₖⁱ} is a group of coefficients for the ith signal, aⁱⱼ represents the j^{th} coefficient for the i^{th} signal, wherein i∈[1,M]. When an output signal segment from the storage unit 312 corresponds to the i^{th} signal, selector 900 selects {a₀ⁱ,a₁ⁱ, . . . ,aₖⁱ} from a predefined set of coefficient groups {{a₀¹,a₁¹, . . . ,aₖ¹}, . . . {a₀²,a₁², . . . ,aₖ²}, . . . , {a₀^{M},a₁^{M}, . . . ,aₖ^{M}}} as the coefficients for the group of weighting units 322 to be multiplied with the input signals of the group of weighting units 322, and feeds the result into the group of combining units 324 for combination operation. The group of storage units 910 in FIG. 9 may be implemented with 310 of FIG. 3, 310′ of FIG. 6 or 310″ of FIG. 7.

Since different weight coefficients form different mathematical expressions, with selector 900, the present invention may achieve the purpose of applying different filtering algorithms to different signals by using only one filter circuit.

It is to be understood by those skilled in the art that, various improvements and modifications can be made to the method and apparatus for filtering a plurality of signals by multiplexing a filter provided in the present invention without departing from the basis of the present invention, the scope of which is to be defined by the appended claims herein.

1. An apparatus for filtering a plurality of signals corresponding to a plurality of channels, each signal comprising a plurality of signal segments, the apparatus comprising:
a group of storage units, for storing the plurality of signals, wherein the group of storage units comprises a plurality of storage units, each of which is used to store corresponding signal segments of each signal and output the stored signal segments in a predefined order; and
a processing unit, for weighting and combining output signal segments from the group of storage units, to obtain a plurality of filtered signals corresponding to the plurality of signals.

2. The apparatus according to claim 1, wherein each storage unit comprises a group of memory elements, the number of which is not less than the number of signals of the plurality of signals, each memory element stores a signal segment.

3. The apparatus according to claim 1, wherein the output signal segments from each of the plurality of storage units correspond to one of the plurality of signals at a clock cycle, and circularly correspond to the plurality of signals according to the predefined order during a predefined period.

4. The apparatus according to claim 3, wherein the group of storage units further comprises a group of combining units, for combining output signal segments from each of the plurality of storage units to be processed with a same weight value.

5. The apparatus according to claim 4, wherein the output signal segments from the group of storage units comprise output signal segments from the group of combining units.

6. The apparatus according to claim 1, wherein the processing unit comprises:
a group of weighting units, for weighting the output signal segments from the group of storage units; and
a group of combining units, for combining the output results from the group of weighting units, to obtain the plurality of filtered signals.

7. The apparatus according to claim 1, further comprising a stabilizer, for stabilizing and outputting the plurality of signals to the group of storage units.

8. The apparatus according to claim 1, further comprising a multiplexer, for multiplexing the plurality of signals and outputting a multiplexed plurality of signals to the group of storage units.

9. The apparatus according to claim 8, wherein the plurality of filtered signals are serial signals and the apparatus further comprises a demultiplexer, for demultiplexing the plurality of filtered signals to a plurality of parallel filtered signals corresponding to the plurality of signals.

10. The apparatus according to claim 1, further comprising a selector, for selecting a group of weight coefficients from a preset set of coefficient groups for one of the plurality of signals corresponding to the current output signal segments from the group of storage units, so as to weight the current output signal segments.

11. A device for use in a wireless communication system, comprising:
a RF module, for receiving a plurality of signals, wherein each signal comprises a plurality of signal segments;
a filtering module, for filtering the plurality of signals, wherein the filtering module comprises:
a group of storage units, for storing the plurality of signals, wherein the group of storage units comprises a plurality of storage units, each of which is used to store corresponding signal segments in each of the plurality of signals and output the stored signal segments in a predefined order; and
a processing module, for weighting and combining the output signal segments from the group of storage units, to obtain a plurality of filtered signals corresponding to the plurality of signals; and
a data processing unit, for processing the plurality of filtered signals.

12. The device according to claim 11, wherein the RF module is further used to transmit the plurality of filtered signals, and the data processing module is further used to generate the plurality of signals to be inputted into the filtering module for filtering.

13. The device according to claim 11, wherein the storage unit comprises a group of memory elements, the number of which is not less than the number of signals of the plurality of signals, each memory element stores a signal segment.

14. The device according to claim 13, wherein, the output signal segments from each of the plurality of storage units correspond to one of the plurality of signals at a clock cycle, and circularly correspond to the plurality of signals according to the predefined order during a predefined period.

15. A method for filtering a plurality of signals, each signal comprising a plurality of signal segments, the method comprising the steps of:
(a) storing the plurality of signals in a group of storage units having a plurality of storage units, each of which stores corresponding signal segments of each signal;
(b) outputting the signal segments stored in the group of storage units in a predefined order; and
(c) weighting and combining the output signal segments from the group of storage units, to obtain a plurality of filtered signals corresponding to the plurality of signals.

16. The method according to claim 15, wherein the storage unit comprises a group of memory elements, the number of which is not less than the number of signals in the plurality of signals, each memory element stores a signal segment.

17. The method according to claim 15, wherein at step (b), the output signal segments from each of the plurality of storage units correspond to one of the plurality of signals at a clock cycle, and correspond to the plurality of signals circularly according to the predefined order during a predefined period.

18. The method according to claim 17, wherein step (a) further comprises a step of:
(i) combining output signal segments from each storage unit to be processed with a same weight value.

19. The method according to claim 18, wherein the output signal segments from the group of storage units comprise the combined signal segments.

20. The method according to claim 15, wherein prior to step (a), the method further comprises the steps of:
(i) stabilizing the plurality of signals; and
(ii) outputting the stabilized plurality of signals to the group of storage units.

21. The method according to claim 15, wherein prior to step (a), the method further comprises the steps of:
(i) multiplexing the plurality of signals; and
(ii) outputting the multiplexed plurality of signals to the group of storage units.

22. The method according to claim 21, wherein the plurality of filtered signals are serial signals and after step (c) the method further comprises a step of:
demultiplexing the plurality of filtered signals into a plurality of parallel filtered signals corresponding to the plurality of signals.

23. The method according to claim 15, wherein step (c) further comprises a step of:
(i) for a signal corresponding to the current output signal segments from the group of storage units, selecting a group of weight coefficients from a preset set of coefficient groups for performing the weight processing.
